(19) United States
(12) Patent Application Publication
(10) Pub. No.: US 2015/0305979 A1
(43) Pub. Date: Oct. 29, 2015

(54) Thermoelectric Medication Cooler

(71) Applicant: Dustin Tintinger, Billings, MT (US)

(72) Inventor: Dustin Tintinger, Billings, MT (US)

(21) Appl. No.: 14/696,958

(22) Filed: Apr. 27, 2015

Related U.S. Application Data
(60) Provisional application No. 61/984,188, filed on Apr. 25, 2014.

(51) Int. Cl. A61J 1/16; F25B 21/02

(52) U.S. Cl. CPC A61J 1/165; F25B 21/02

(57) ABSTRACT

The present invention provides a thermoelectric medication cooler including a receptacle having a base with an outer perimeter and at least one vertically oriented sidewall extending therefrom forming a defined interior chamber. The defined interior chamber is enclosed and removably fastened by a lid hingedly attached to the sidewall and includes a tray having at least one compartment configured to support one or more vials of insulin. The defined interior chamber further includes a thermoelectric cooling system including at least one thermoelectric cooling device and a cooling fan, wherein the thermoelectric cooling device is designed to lower the temperature within the defined interior chamber below the ambient temperature and the cooling fan is configured to extract heat from therein and direct it through a vent on the outside of the receptacle. The thermoelectric cooling device is configured to be powered by a power source.

### CROSS REFERENCE TO RELATED APPLICATION

This application claims the benefit of U.S. Provisional Application No. 61/984,188 filed on Apr. 25, 2014. The above identified patent application is herein incorporated by reference in its entirety to provide continuity of disclosure.

### BACKGROUND OF THE INVENTION

1. Field of the Invention

The present invention relates to thermoelectric coolers. More specifically, the present invention pertains to an improved thermoelectric medication cooler comprising a receptacle forming a defined interior volume having a tray configured to hold one or more vials and a thermoelectric cooling system configured to maintain an optimal storage temperature.

Certain ailments, such as diabetes, require regular applications of medication. Many diabetics take insulin by injections to control blood sugar level. Other physical conditions may also require the repeated application or availability of medication either on a temporary of lifetime basis. These medications, however, are subject to rapid degradation of properties as a result of temperature and other environmental conditions.

Therefore, these types of medications need to be kept in a temperature-controlled and safe environment. For example, insulin, like many other medications, should preferably be kept at approximately 35° Fahrenheit, however the vials of insulin generally last for one month when stored at room temperature (59° F. to 86° F.). However, the insulin becomes unsafe for use if permitted to warm to a temperature above 86° Fahrenheit. Consequently, there exists a need for a temperature controlled environment for these medications, especially during situations such as travel.

Thermoelectric cooling systems have been particularly effective in maintaining a temperature controlled environment. Thermoelectric cooling systems use the Peltier effect to create a heat flux between the junctions of two different types of materials. A Peltier thermoelectric heat pump is a solid-state active heat pump, which transfers heat from one side of the device to the other by the consumption of electrical energy depending on the direction of the current. The main applications for a thermoelectric cooling system are for heating and/or cooling. In the cooling application, a cold junction is the place where the heat source or load is located and where energy in the form of heat is absorbed when current passes from one metal to another. The hot junction is the place where the heat sink is located, which is attached to a heat exchanger. Heat is liberated through the heat exchanger when the current passes from one metal to another and then transferred to the ambient environment.

The present invention provides a thermoelectric medication cooler comprising a receptacle having a base with at least one vertically oriented sidewall extending from an outer perimeter of the receptacle forming a defined interior chamber. The receptacles further includes a lid hingedly attached to one of the sidewalls to removably fasten and enclose the defined interior chamber. The defined interior chamber comprises a tray including at least one compartment configured to support one or more vials of insulin. In addition, the defined interior chamber further includes a thermoelectric cooling system comprising a thermoelectric cooling device and a cooling fan, wherein the thermoelectric cooling system lowers the temperature within the defined interior volume below the ambient temperature and the cooling fan extracts heat through a vent on the outside of the receptacle. The thermoelectric cooling device is also electrically connected to a power source to drive the thermoelectric cooling system.

2. Description of the Prior Art

Devices have been disclosed in the prior art that medication coolers. These include devices that have been patented and published in patent application publications. Some of these devices disclose a portable mediation cooler having a thermoelectric cooler, a processor and a rechargeable battery. Other devices disclose a thermoelectric insulin cooling bag. These devices, however, do not disclose a thermoelectric cooling system comprising a thermoelectric cooling device and a cooling fan configured to cool a defined interior chamber configured to support one or more vials of insulin. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 8,225,616 to Wilkinson is a portable medicine cooler and a method of operating the same. The Wilkinson device provides a shell having a door providing access to a cavity within the shell for a medicine to be cooled. There is a cooling structure coupled to the shell, which includes a thermoelectric cooler interposing a heat sink and a vial receiver. The cooling structure further includes electronic cooling control having at least a processor, a temperature sensor, and a battery. However, the Wilkinson device does not provide a receptacle having a thermoelectric cooling system including a thermoelectric cooling device and a fan.

Similarly, U.S. Pat. No. 5,865,032 to MacPherson is a portable thermoelectric cooling medicine kit. The MacPherson device provides a box-like case having a heat pump mounted within for cooling a vial of medicine. The case further includes a portable electric power mounted thereon and electrically connected to the heat pump. Within the case there is a container having a cavity designed to receive a vial and a biasable cap. However, the MacPherson device does not disclose a receptacle having a thermoelectric cooling system and an insulating liner configured to optimize cooling efficiency.

U.S. Pat. No. 6,935,133 to Keeter is a temperature control medicine carrying case having an insulated housing with interior compartments and a cooling mechanism. An interior pouch is located within the insulated housing configured to receive the cooling mechanism. The interior compartments are configured to receive a container of medicine or medical devices for administration of the medicine. The Keeter device further provides a fastening mechanism for releasably securing said housing in a closed position. However, the Keeter device does not provide a fan within a thermoelectric cooling system.

U.S. Pat. No. 4,429,793 to Ehmann relates to a pocket-sized diabetic traveling case having a front cover, a back cover and a spine pivotally attaching the front cover and back cover. The inside of the front cover includes a pouch adapted to hold a package of alcohol swabs or wipes. The inside of the back cover includes a pair of elastic straps, wherein the upper strap is adapted to releasably receive an insulin bottle, and the lower strap holds a plastic container of freezing material. However, the Ehmann device does not provide a thermoelectric cooling system.

U.S. Pat. No. 8,544,286 to Janssen relates to a monitoring device used in cooperation with a portable cooling device to maintain a temperature of medications. The cooling device includes a body forming an interior volume configured to store medication and a power source in communication with the cooling device. The monitoring device that is utilized both within and separately from the cooling device includes a processor driven circuitry for recording temperature within the interior volume. The monitoring device includes a temperature display and an audible output alert in response to a recorded temperature outside a preset temperature range. However, the Janssen device does not provide a thermoelectric cooling system.

Finally, U.S. Pat. No. 7,597,196 to Langone describes a portable device for transporting medication under refrigeration. The Langone device provides an insulated medication carrying container having an outer shell forming an interior volume, at least one cooling component, and a closure mechanism that is configured to enclose the container. The cooling components are housed within the shell and include chemical cold packs and cold gels. However, the Langone device does not provide a device comprising a thermoelectric cooling system.

The devices disclosed in the prior art have several known drawbacks. These devices are limited as they do not provide a thermoelectric cooler having a fan and a thermoelectric cooling device. The present invention overcomes these limitations by disclosing a receptacle having a defined interior chamber. The interior chamber includes a tray for holding medications, such as, vials of insulin, and a thermoelectric cooling system designed to lower the temperature within the defined interior chamber below the ambient temperature. The thermoelectric cooling device includes a cooling fan for extracting heat from the thermoelectric cooling device through a vent to allow the temperature within the defined interior chamber to be below the ambient temperature. It is therefore submitted that the present invention is substantially divergent in design elements from the prior art, and consequently it is clear that there is a need in the art for an improvement to thermoelectric medication coolers. In this regard, the instant invention substantially fulfills these needs.

### SUMMARY OF THE INVENTION

In view of the foregoing disadvantages inherent in the known types of thermoelectric medication coolers now present in the prior art, the present invention provides a new and improved thermoelectric medication cooler wherein the same can be utilized for maintaining an optimal storing temperature for medication below an ambient temperature.

It is therefore an object of the invention to provide a new and improved thermoelectric medication cooler that has all of the advantages of the prior art and none of the disadvantages.

Another object of the present invention is to provide a new and improved thermoelectric medication cooler comprising a receptacle forming a defined interior chamber having a tray with at least one compartment configured to support one or more vials of insulin.

Yet another object of the present invention is to provide a new and improved thermoelectric medication cooler, wherein said receptacle further comprising a thermoelectric cooling system comprising at least one thermoelectric cooling device and a cooling fan.

Another object of the present invention is to provide a new and improved thermoelectric medication cooler, wherein said receptacle includes a vent configured to allow the cooling fan to extract heat therethrough to keep the interior volume cool.

Still yet another object of the present invention is to provide a new and improved thermoelectric medication cooler is configured to be powered by a power source.

Still yet another object of the present invention is to provide a new and improved thermoelectric cooler wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a side perspective of the present invention.

FIG. 2 shows an overhead perspective of the thermoelectric cooling system of the present invention.

FIG. 3 shows a side cross sectional view of the thermoelectric cooling system of the present invention.

### DETAILED DESCRIPTION OF THE INVENTION

References are made herein to the attached drawings. Like reference numerals are used throughout the drawings to depict like or similar elements of the thermoelectric medication cooler. For the purposes of presenting a brief and clear description of the present invention, the preferred embodiment will be discussed as used for storing vials of insulin. The figures are intended for representative purposes only and should not be considered to be limiting in any respect.

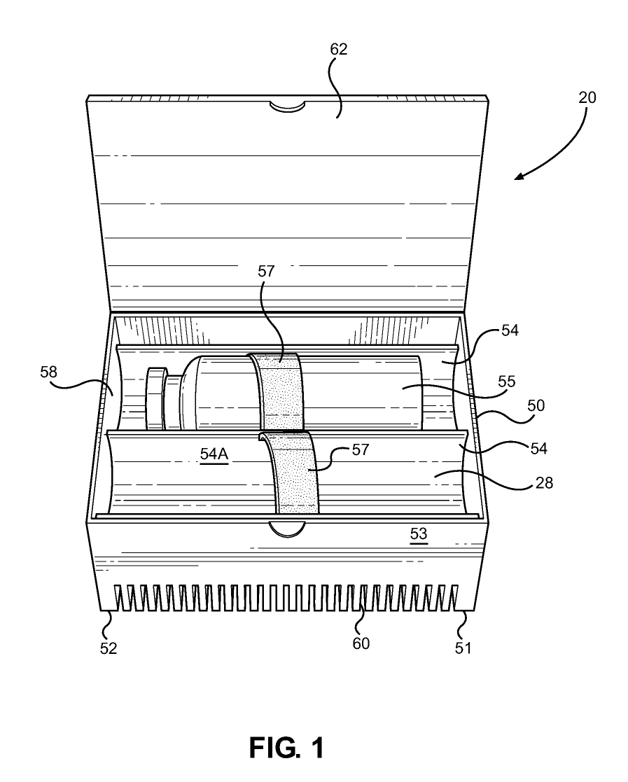

Referring now to FIG. 1, there is shown a side perspective of the thermoelectric medication cooler 20. The thermoelectric medication cooler 20 comprises a receptacle 50 having a base 51 with an outer perimeter 52, wherein at least one vertically oriented sidewall 53 extends therefrom forming a defined interior chamber. The defined interior chamber is configured to hold a thermoelectric cooling system and a tray 28, acting as a cold plate for the thermoelectric cooling system, wherein the thermoelectric cooling system that preferably sits on an interior surface of the base 51 and the tray 28 sits on top thereof.

The tray 28 includes at least one compartment 54 having a semicircular recess 54A configured to support one or more vials 55 of insulin. In the preferred embodiment, the thermoelectric medication cooler 20 is configured to store a pair of vials 55 of insulin. However, it is also recognized that the thermoelectric medication cooler 20 may also be configured to hold as little as one vial 55 or any plurality of vials 55. It is also contemplated that the compartments 54 also support other suitable types of medications that may require cooling. Each compartment 54 comprises a semicircular recess 56 that is configured to partially receive a vial 55 of insulin and a strap 57 that is configured to removably fasten the vial 55 within the compartment 54. It is contemplated, in other embodiments, each compartment 54 include other means for removably securing the vial 55 therein.

In addition, the defined interior chamber should be sufficiently insulated so that the appropriate temperature is maintained therein. Therefore, the receptacle 50 further comprises an insulating liner 58 configured to optimize cooling efficiency and to maintain appropriate temperature therein. The insulating liner 58 may be formed of polyurethane, polystyrene, polypropylene, ABS, polyethylene, vacuum panels, or other suitable insulating materials. Attached to an upper end of the sidewall 53 is a lid hingedly attached configured to removably fasten and enclose the defined interior chamber. The lid 62 is preferably well-fitted, and can be sealed with a fastener that is readily available in the art and configured to optimize cooling efficiency and maintain appropriate temperature within the defined interior chamber.

Furthermore, a vent 60 is located on the bottom of sidewall 53 and along the base 51. Due to the thermoelectric cooling system later described in detail in the following paragraphs, the thermoelectric cooling system absorbs unwanted heat, which then needs to be extracted from a heat sink. The thermoelectric cooling system comprises a cooling fan that dissipates heat therefrom and ejects the heat from the defined interior chamber through the vent 60 to optimize cooling efficiency and maintain an appropriate temperature therein. In an alternative embodiment, the vent 60 is located on the sidewall 53, wherein the thermoelectric cooling system is placed on its side to align with the sidewall 53.

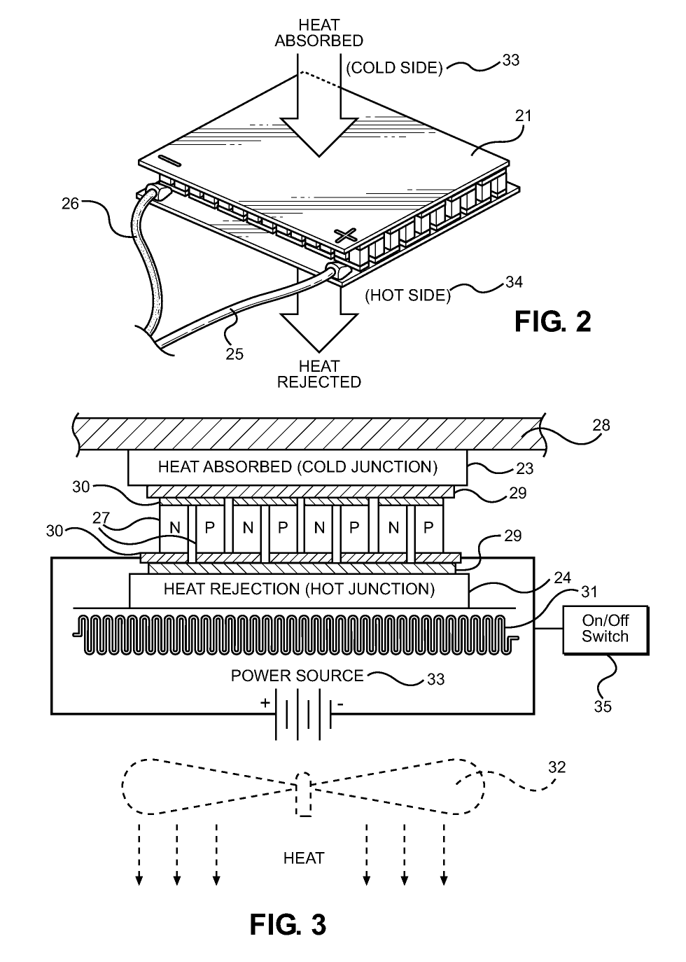

Referring now to FIGS. 2 and 3, there are shown a side perspective view and a cross-sectional view of the solid-state thermoelectric arrangement which is preferably utilized for the thermoelectric cooling system 21 of the thermoelectric medication cooler. In this way, the thermoelectric arrangement is particularly advantageous for transferring quantities of heat when connected to a heat absorbing device on one side and a heat dissipating device on the other.

Preferably, the thermoelectric cooling device 22 of the thermoelectric cooling system 21 is very slim and compact. Generally, these thermoelectric cooling devices 22 are available in a great variety of sizes, shapes, operating currents, operating voltages, and ranges of heat pumping capacity, and other embodiments of the thermoelectric medication cooler 20 may be composed of such sizes and shapes of thermoelectric cooling devices 22. The thermoelectric cooling system 21 comprises at least one thermoelectric cooling device 22, wherein the thermoelectric cooling device 22 comprises a cold junction 23 and a hot junction 24 that are preferably ceramic substrates. As depicted in FIG. 2, heat is absorbed from the cold 33 side and rejected from the hot side 34.

Between the cold junction 23 and the hot junction 24, the thermoelectric cooling device includes a pair of electric insulators 29 that sandwich a two groups of electric conductors 30. Between the groups of electric conductors 30, the thermoelectric cooling device 22 further includes a plurality of electric carriers 27 comprising pairs of “N” type and “P” type semiconductors. Specifically, on the cold side 33, the cold junction 23 is typically affixed to a structure that acts as a cold plate, which is adapted to absorb unwanted heat. For the thermoelectric medication cooler 20, this structure acting as a cold plate is the tray 28 configured to hold the vials of insulin. On the opposite face of the cold junction 23, the electric insulator 29 acts as a heat conductor. On the other side of the electric insulator 29, the first group of electric conductors 30 act to attach a respective pair of electric carriers 27 such that an electrical circuit may be maintained.

On the hot side 34, the second group of electric conductors 30 connects the plurality of electric carriers 27 in an offset manner that maintains the electrical circuit. For example, if the electric conductors 30 of the cold junction 23 connect pairs of “P” and “N” semiconductors, the electric conductors 31 of the hot junction 24 are shifted one over to connect pairs of “N” and “P” semiconductors. On the other side of the second group of electric conductors 30 is an electric insulator 29 with the hot junction 24 attached thereto. On the opposite face of the hot junction 24, a heat sink 31 is attached thereto, wherein a cooling fan 32 is used to dissipate heat from the heat sink 31 and to transfer the heat away from the heat sink 31. The heat is then ejected from within the defined interior chamber of the receptacle through a vent on the base and sidewall. The hot junction 24 further includes a positive connection 25 and a negative connection 26 to a power source 33. Preferably, the power source 33 is a rechargeable battery having a USB configured for power delivery, however, other embodiments include other suitable types of power sources 33.

The power source 33 is particularly important as it provides the energy to move the electrons through the circuit. Heat is absorbed from the vials of insulin through the cold plate and then absorbed by the cold junction 23. At the cold junction 23, the energy (heat) is absorbed the electrons as they pass from a low energy level in the “P” type semiconductor to a higher energy level in the “N” type semiconductor. At the hot junction 24, the energy is expelled to a heat sink 31 as electrons move from a high energy level to a lower energy level. The cooling fan 32 further aides in circulating heat away from the hot junction 24. In addition, the power source 33 is preferably electrically connected to an on/off switch 35.

The thermoelectric cooling device 22 in this particular arrangement allows a current to pass across resulting in a temperature gradient. The temperature of the hot junction 24 is kept low by removing the generated heat through the cooling fan 32, therefore, the temperature of the tray 28 acting as the cold plate can be cooled. Preferably, the material used to compose the thermoelectric semiconductors is Bismuth Telluride because of the distinct “N” and “P” characteristics. Other thermoelectric materials include Lead Telluride, Silicon Germanium, and Bismuth-Antimony alloys, which may be used in other specific embodiments.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A thermoelectric medication cooler, comprising:
a receptacle comprising a base having at least one vertically oriented sidewall extending from an outer perimeter of said receptacle forming a defined interior chamber;
said defined interior chamber comprising a tray including at least one compartment configured to support one or more vials of insulin;
a lid hingedly attached to one of said sidewalls configured to removably fasten and enclose said defined interior chamber;
a thermoelectric cooling system comprising at least one thermoelectric cooling device and a cooling fan;
wherein said thermoelectric cooling system is designed to lower temperature within said defined interior chamber below ambient temperature;
each said thermoelectric cooling device includes a cold junction and a hot junction;
wherein said cold junction is attached to said tray and a heat sink is attached to said hot junction;
said cooling fan for extracting heat from said heat sink and directing the heat outside of said receptacle through a vent.
at least one said thermoelectric cooling device is configured to be powered by a power source.

2. The thermoelectric medication cooler of claim 1, wherein said vent is disposed on said sidewall or on said base.

3. The thermoelectric medication cooler of claim 1, further including an on/off switch configured to activate and deactivate said thermoelectric cooling system.

4. The thermoelectric medication cooler of claim 1, wherein said power source includes a rechargeable battery and a USB configured for power delivery.

5. The thermoelectric medication cooler of claim 1, further comprising an insulating liner configured to optimize cooling efficiency.

6. The thermoelectric medication cooler of claim 1, wherein each said compartment includes a semicircular recess configured to receive said vials of insulin.

7. The thermoelectric medication cooler of claim 6, wherein each said compartment further includes a strap configured to fasten said vial of insulin within said compartment.
